(19) United States
(12) Patent Application Publication
(10) Pub. No.: US 2025/0010115 A1
(43) Pub. Date: Jan. 9, 2025

(54) FIRE SPRINKLER SHUT OFF TOOL

(71) Applicant: FST INNOVATION PTY LTD, Melbourne, VIC (AU)

(72) Inventor: Shae METE, Melbourne, VIC (AU)

(73) Assignee: FST INNOVATION PTY LTD, Melbourne, VIC (AU)

(21) Appl. No.: 18/721,005

(22) PCT Filed: Oct. 12, 2022
(86) PCT No.: PCT/AU2022/051228

§ 371 Date: Jun. 17, 2024

(30) Foreign Application Priority Data
Oct. 12, 2021 (AU) 2021250875

(51) Int. Cl. A62C 37/20; A45B 25/16

(52) U.S. Cl. CPC A62C 37/20; A45B 25/16; A45B 2200/1009

(57) ABSTRACT

A fire sprinkler shut off tool comprising a body comprising a collar, a casing and a shut off tool hydraulic seal or part thereof to block fluid is disclosed. The collar surrounds a sprinkler or an adaptor, the casing comprises a wall and defines a conduit, the casing also comprises one or more fluid outlet. The shut off tool also comprises a valve movable between an open position to allow fluid to exit from the one or more fluid outlet and a closed position in which fluid is blocked from exiting the one or more fluid outlet and one or more fastener to connect to the sprinkler or adaptor. Also discloses is a method of shutting off a fire sprinkler and a method of manufacturing the fire sprinkler shut off tool.

### FIELD OF THE INVENTION

The present invention relates to a fire sprinkler shut off tool comprising a hydraulic seal or part thereof to block fluid. More particularly, this invention relates to a fire sprinkler shut off tool comprising a hydraulic seal or part thereof to block fluid and a valve movable between an open position and a closed position.

### BACKGROUND TO THE INVENTION

Fire sprinklers are designed to distribute an extinguishing fluid, such as water, throughout a building as widely as possible. As such, they are generally pressurised to high levels and activation can cause considerable damage to buildings and contents. For example, activation of fire sprinklers in offices can damage computers and files and activation in retail stores can cause water damage to stock. Non-fire related activations of fire sprinklers result in significant financial loss, both from the water damage and the downtime to businesses. This negative attribute of sprinkler protection has limited the take up of the life saving safety systems.

Fire sprinklers can also pose a safety threat to personnel involved with building testing and maintenance, regardless of whether their work is related to the sprinklers. For example, ladders or other equipment can come into contact with sprinklers, potentially activating the sprinklers.

Fire sprinkler systems can include numerous sprinklers, which are generally installed about four metres apart. These sprinklers require maintenance and testing and can require activation to allow a system to be drained or to check operation. Also, it can be difficult to determine whether a sprinkler is pressurised and a fire sprinkler can be dangerous and difficult to switch off once activated.

WO 2015/003226, the publication of PCT/AU2014/050119, to Shae METE and assigned to FIRE SPRINKLER TECHNOLOGIES PTY LTD, describes a specially designed and fitted sprinkler that can attach to a drain tool, and separately describes a drain tool, which can be used to capture water escaping from a fire sprinkler to prevent or minimise water damage in the case of unnecessary sprinkler activation.

U.S. Pat. No. 4,923,013 describes a tubular pipe fitting that is installed intermediate the water distribution pipe and a fire sprinkler. Once the fire sprinkler is activated, water flows through the tubular pipe fitting to spin a paddle wheel which in turn rotates a gear train so that, after a predetermined time interval, a valve member seals the internal channel of the tubular pipe fitting to shut-off flow.

The Shutgun product, described in WO 2012/048415, the publication of PCT/CA2011/001151, essentially describes a cork-like compressible rubber surface, disposed on a clamping arm, which is fitted against a fire sprinkler to stop water flow. The nature of this product is such that it requires a trained tradesperson level of expertise to operate.

Some of the drawbacks of the available fire sprinkler shut off tools are that multiple tools may be required for different sprinkler types and mountings. Also some require, at the very least, an experienced ‘handyman’ level of knowledge to operate, because operation is not intuitive. Some of these shut off tools also require the occupant to climb a ladder to use the tool, while being sprayed with water discharging at significant pressure. In such a case the person using the tool will be completely saturated and therefore not likely to ever use it. Even attending fire-fighters will be much more likely to shut off the entire sprinkler system than shutting off specific sprinklers.

There remains a need for alternative mechanisms to shut off fire sprinklers.

The reference to any prior art in this specification is not, and should not be taken as, an acknowledgement or any form of suggestion that the prior art forms part of the common general knowledge.

### SUMMARY OF THE INVENTION

Generally, embodiments of the present invention relate to a fire sprinkler shut off tool.

In a broad form, the invention relates to a fire sprinkler shut off tool comprising a hydraulic seal or part thereof to block fluid.

The fire sprinkler shut off tool of the invention is of particular advantage as it allows safe, controlled and on-demand shut-off at the sprinkler site. Moreover, no special training is required and the shut off tool is a suitably low-cost device that may be stored in each room; common area; or as convenient so as to provide the earliest capability to shut off flow to minimise loss.

In a first aspect, although it need not be the only or indeed the broadest aspect, the invention provides a fire sprinkler shut off tool comprising:
a body comprising a collar, a casing and a shut off tool hydraulic seal or part thereof to block fluid, the collar for surrounding a sprinkler or an adaptor, the casing comprising a wall and defining a conduit, the casing also comprising one or more fluid outlet;
a valve movable between an open position to allow fluid to exit from the one or more fluid outlet and a closed position in which fluid is blocked from exiting the one or more fluid outlet; and one or more fastener to connect to the sprinkler or adaptor.

In a second aspect, the invention provides a method of shutting off a fire sprinkler, the method comprising installing the fire sprinkler shut off tool of the first aspect over a fire sprinkler in need of being shut off.

In a third aspect, the invention provides a method of shutting off a fire sprinkler, the method comprising:
installing a fire sprinkler shut off tool over a sprinkler in need of shutting off or an adaptor, the fire sprinkler shut off tool comprising:
   a body comprising a collar, a casing and a shut off tool hydraulic seal or part thereof to block fluid, the collar for surrounding a sprinkler or an adaptor, the casing comprising a wall and defining a conduit, the casing also comprising one or more fluid outlet;
   a valve movable between an open position to allow fluid to exit from the one or more fluid outlet and a closed position in which fluid is blocked from exiting the one or more fluid outlet; and
   one or more fastener to connect to the sprinkler or adaptor.

In a fourth aspect, the invention provides a method of manufacturing a fire sprinkler shut off tool comprising:
providing a body comprising a collar, a casing and a shut off tool hydraulic seal or part thereof to block fluid, the collar for surrounding a sprinkler or an adaptor, the casing comprising a wall and defining a conduit, the casing also comprising one or more fluid outlet;
providing a valve movable between an open position to allow fluid to exit from the one or more fluid outlet and a closed position in which fluid is blocked from exiting the one or more fluid outlet; and
providing one or more fastener to connect to the sprinkler or adaptor.

In one embodiment of any one of the above aspects, the collar may be annular. The collar may comprise a top surface. The collar top surface may be annular. The collar may comprise a larger diameter than a sealing surface diameter of the sprinkler to which the sprinkler shut off device is to be fitted.

In another embodiment of any one of the above aspects, the collar may be integral with the casing. The collar may be comprised within the casing.

In still another embodiment of any one of the above aspects the body may comprise two or more pieces. The two or more pieces may comprise a collar piece and a casing piece.

In yet another embodiment of any one of the above aspects, the casing may be movable relative to the collar from an open position in which fluid can escape from the one or more fluid outlet to a closed position in which the one or more fluid outlet is closed so that no fluid can escape. The movement may be along an extent of a wall. The wall may comprise a collar wall and/or a casing wall. The movement may be linear, rotational or linear and rotational. The movement may close the valve. The movement may be reversible.

In still another embodiment according to any one of the above aspects, the one or more fluid outlet comprises a size at least as large as the conduit. The size of the one or more fluid outlet may be the combined size of the one or more exit port compared to the size of the conduit. The size may be the area in mm² or cm². In a preferred embodiment, the one or more fluid outlet is sized so fluid exits with minimal or no restriction or pressure build-up.

In one embodiment of any of the above aspects, the shut off tool hydraulic seal or part thereof comprises a ring such as, an O-ring or a plurality of O-rings. The shut off tool hydraulic seal or part thereof may be comprised within the collar or proximal to the collar. The shut off tool hydraulic seal or part thereof may comprise a planar surface or a surface which compresses to planar on sealing. The shut off tool hydraulic seal or part thereof may engage with a correspondingly shaped element on the sprinkler or adaptor. The correspondingly shaped element on the sprinkler or adaptor may be retrofitted or retro-designed for the sprinkler or adaptor.

In yet another embodiment of any one of the above aspects, the casing comprises one or more outlet seal or part thereof. The one or more outlet seal or part thereof may comprise an O-ring or a plurality of O-rings. The one or more outlet seal or part thereof may comprise an open position outlet seal or part thereof and a closed position outlet scal or part thereof. The open position outlet seal or part thereof may be above the closed position outlet seal or part thereof. The one or more outlet seal or part thereof may comprise a planar surface or a surface which compresses to planar on sealing. The one or more outlet seal or part thereof may engage with a correspondingly shaped element on the valve such as, a sleeve. The casing may comprise a structural feature to accommodate each of the one or more outlet seal or part thereof. Each structural feature may comprise a groove.

In one embodiment, one or more interfitting retaining elements may hold the casing in the closed position. The one or more interfitting retaining elements may comprise corresponding retaining elements disposed on the collar and the casing. The one or more interfitting retaining elements may operate in both the open position and the closed position or only the closed position. The interfitting retaining element may comprise one or more: corresponding thread; male component; female component; or other fasteners. The one or more male component may comprise one or more protrusion. The one or more female component may comprise one or more recess. The one or more female component may comprise one or more groove. The one or more male component may comprise one or more tabs. The tabs may lock in the grooves which may prevent return travel or release.

In one embodiment of any one of the above aspects, the one or more fastener comprises a mechanical fastener dimensioned to fasten to a mechanical element on the one or more sprinkler or adaptor. The mechanical element on the one or more sprinkler or adaptor may be a complementary fastener or a native sprinkler or adaptor mechanical element. The one or more fastener may comprise one or more of: one or more circlip; a plurality of tines; one or more retaining arcs; and a plurality of deflector fingers. The one or more fastener may be comprised within the collar or proximal to the collar. The one or more fastener may be disposed above or below the hydraulic seal or part thereof. The one or more fastener may be disposed on the casing. The plurality of deflector fingers may be disposed for fastening to a deflector of the sprinkler.

According to another embodiment of any one of the above aspects, the body may comprise a valve seat. The valve seat may be comprised on the casing or collar. The valve seat may form a seal with a valve member when the valve is closed. The valve seat may be located above the one or more fluid outlet.

In still another embodiment of any one of the above aspects, an actuator may be comprised. The actuator may be operated proximally or distally to the sprinkler. The actuator may comprise one or more of a wheel; a cord; a shaft; or a lever.

According to yet another embodiment of any one of the above aspects, the sprinkler or adaptor may be a connectable sprinkler or connectable adaptor comprising one or more sprinkler or adaptor fastener for attachment to a tool such as, a drain tool or the shut off tool. The connectable sprinkler or connectable adaptor may comprise a sprinkler hydraulic seal or part thereof.

According to still another embodiment of any one of the above aspects, the sprinkler or adaptor may comprise a traditional or non-connectable sprinkler or adaptor. The traditional or non-connectable sprinkler or adaptor may be retro-fitted with a sprinkler hydraulic seal or part thereof and/or one or more mechanical element dimensioned for fastening with the one or more fastener.

In another embodiment of any one of the above aspects, the adaptor may comprise a sprinkler adaptor; a sprinkler pipe adaptor; or a sprinkler system adaptor. The adaptor may be an intermediary allowing connection between a sprinkler or sprinkler head and a sprinkler pipe.

In yet another embodiment of any one of the above aspects, the valve is moved from the open position to the closed position by applying force to an actuator. The force may be applied by hand. The force may comprise one or more of: pushing; pulling; rotating; rotating and pushing; rotating and pulling; twisting; twisting and pushing; twisting and pulling; sliding; sliding and twisting; and sliding and rotating. The valve may comprise a clasp to lock the valve in the closed position. The clasp may be releasable.

According to still another embodiment of any one of the above aspects, the valve may comprise a plug valve; a butterfly valve; a ball valve; diaphragm valve; and/or a sleeve valve.

In another embodiment of any one of the above aspects, the valve comprises a valve member. The valve member may comprise a plug or stopper; a disc; a ball; a diaphragm; and/or a sleeve. The disc may comprise a rotatable disc. The disc may be circular. The rotatable disc may be rotated by pulling on the actuator. The actuator may comprise a cord attached at a proximal end to the rotatable disc. The cord may extend externally from the fire sprinkler. The valve member may comprise a plug or stopper. The plug or stopper member may be mounted on the actuator. The valve member may comprise a sleeve surrounding the body.

According to any one of the above embodiments, when the valve comprises a sleeve valve, applying the device may move the sleeve relative to the housing to an intermediate sleeve open position in which the one or more fluid outlets are open. The intermediate sleeve open position may be a raising or lifting of the sleeve. Once the device is installed on the fire sprinkler or the adaptor, the sleeve may move relative to the housing to a sleeve closed position in which the one or more fluid outlets are closed. The sleeve closed position, compared to the intermediate sleeve open position, may be a dropping or a lowering of the sleeve. The closed position may be biased by gravity and/or a weight of a handle or rod. In another embodiment the sleeve may be rotated relative to the casing so that the sleeve open position aligns the one or more fluid outlet with corresponding one or more valve outlet in the sleeve, and in the sleeve closed position, the sleeve may be rotated relative to the casing so that the one or more fluid outlet and the corresponding one or more valve outlet in the sleeve are not aligned.

The body may comprise a trigger. Applying the body over the sprinkler or the adaptor may depress the trigger. The trigger may comprise a bias such as, a spring. The trigger may comprise vertical struts which in a biased position prevent a retainer from fastening to the sprinkler or the adaptor. The vertical struts may extend from a base. The base may be disposed to make contact with the sprinkler or the adaptor. The retainer may be biased to move inward. The bias may comprise a spring such as, a leaf spring. Inserting the sprinkler or the adaptor may move the trigger against the bias to move vertical struts away from contact with the retainer so the retainer fastens to the sprinkler or the adaptor.

According to any one of the above aspects, a secondary flow actuator may be comprised. The secondary flow actuator may move the valve member to the open position to allow flow through the flow passage. The secondary flow actuator may comprise a responsive element such as, a temperature responsive or heat sensing element.

In another embodiment of any one of the above aspects, a failsafe sprinkler may be comprised on the device. The failsafe may comprise a responsive element such as, temperature responsive bulb.

The casing wall may define the one or more conduit. The conduit may comprise one or more conduit. The conduit, or at least its main intake and main channel may be centrally disposed in the casing. The casing may comprise a bottom wall and the one or more outlets may be comprised in a casing side wall. The casing bottom wall may be continuous that is, may be without any holes or outlets.

According to yet another embodiment of the above aspects, the casing comprises an internal surface and an external surface. The one or more inter-fitting retaining elements may be disposed on the internal surface.

In one embodiment of any one of the above aspects, the fire sprinkler shut off device comprises an intentional supervisory leak. The intentional supervisory leak may result from a channel. The channel may be through the valve or valve member or the hydraulic seal or part thereof. The channel may only be oriented to allow fluid flow when the valve or valve member is closed. The deliberate leak may allow only sufficient water to cause a leak and not sufficient water to extinguish a fire.

According to still another embodiment of any one of the above aspects, the fire sprinkler or adaptor comprises a connectable fire sprinkler or adaptor configured to engage with a drain tool or the fire sprinkler shut off tool. The connectable sprinkler or adaptor may be a sprinkler or adaptor as described in WO 2015/003226, the publication of PCT/AU2014/050119, to Shae METE and assigned to FIRE SPRINKLER TECHNOLOGIES PTY LTD.

In one embodiment of any one of the above aspects, the fire sprinkler or adaptor comprises a fire sprinkler or adaptor fastener for complementary fastening with the one or more fastener. The fire sprinkler or adaptor fastener may comprise a conventional sprinkler or sprinkler head component such as, the deflector.

In another embodiment of any one of the above aspects, the fire sprinkler comprises a pendant fire sprinkler or a non-protruding fire sprinkler (concealed or flush mounted sprinkler). When the fire sprinkler is a non-protruding fire sprinkler it may further comprise a cover plate. The cover plate may be ejected when the flow actuator activates.

According to yet another embodiment of any one of the above aspects, the fire sprinkler comprises one or more of: an attachment for installation on a pipe network; a deflector; and a flow actuator. The flow actuator may comprise a temperature responsive element such as, a bulb or soldered link. A deflector plate may be suspended from a deflector housing by one or more suspender. Each of the one or more suspender may comprise a suspender rod or suspender cable.

In another embodiment of any one of the above aspects, the device may comprise a handle or rod. The handle or rod may comprise a length suitable to extend from a hand-held operable height to the fire sprinkler. The handle or rod may comprise two or more telescoping segments.

According to any one of the above aspects, the device may comprise a diverter such as, an umbrella. The diverter may comprise a deflecting surface such as, a canopy.

In one embodiment according to any one of the above aspects, the fire sprinkler shut off tool is positioned external to said sprinkler in need of being shut off. The tool may be inserted over the sprinkler in need of being shut off or the adaptor. The insertion may comprise pushing, rotating and/or pushing and rotating.

Further aspects and/or features of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIGS. 1A; 1B; and 1C: show one embodiment of a shut off tool according to the invention in: retracted and closed (1A); extended and closed (1B); and extended and open (1C) configurations.

FIGS. 2A and 2B: show a section view of part of a shut off tool according to a spindle valve embodiment of the invention, in an open (2A) and shut (2B) configuration.

FIGS. 3A; 3B and 3C: show phantom and section views of part of a shut off tool according to a butterfly valve embodiment of the invention, in an open (3A) and shut (3B and 3C) configurations.

FIGS. 4A; 4B and 4C: show phantom and section views of part of a shut off tool according to a first sleeve valve embodiment of the invention, in an open (4A and 4B) and shut (4C) configuration.

FIGS. 4D; 4E; 4F; 4G; 4H; 4I; 4J; 4K; 4L and 4M: are various diagrams illustrating a second sleeve valve embodiment of the invention or component parts.

FIGS. 5A and 5B: show an embodiment of a device according to the invention stored on a wall for ready availability (5A) and in use (5B).

FIG. 6: is a schematic diagram showing one embodiment of a device according to the invention connected to a sprinkler head body.

FIGS. 7A; 7B and 7C: are schematic diagrams showing one embodiment of a device according to the invention connecting to a sprinkler where the one or more fastener comprises tines.

FIGS. 8A; and 8B: are schematic diagrams showing one embodiment of a device according to the invention connecting to a sprinkler deflector.

FIG. 9: shows one embodiment of a device according to the invention featuring a cord for actuation.

FIGS. 10A; 10B; and 10C: show screenshots of a video taken showing subjecting a fire sprinkler to heat (10A); the fire sprinkler activated and dispensing water (10B); and the fire sprinkler shut off (10C) with one embodiment of a device according to the invention.

FIG. 11 shows a photograph of an embodiment of the invention comprising a failsafe sprinkler.

FIGS. 12 and 13 show illustrations of two methods according to the invention.

Skilled addressees will appreciate that elements in the drawings are illustrated for simplicity and clarity and have not necessarily been drawn to scale. For example, the relative dimensions of some elements in the drawings may be distorted to help improve understanding of embodiments of the present invention.

### DETAILED DESCRIPTION OF THE INVENTION

Embodiments of the present invention relate to a fire sprinkler shut off tool. In one embodiment, advantageously, the fire sprinkler shut off tool comprises a hydraulic seal or part thereof to block fluid from exiting from the sprinkler.

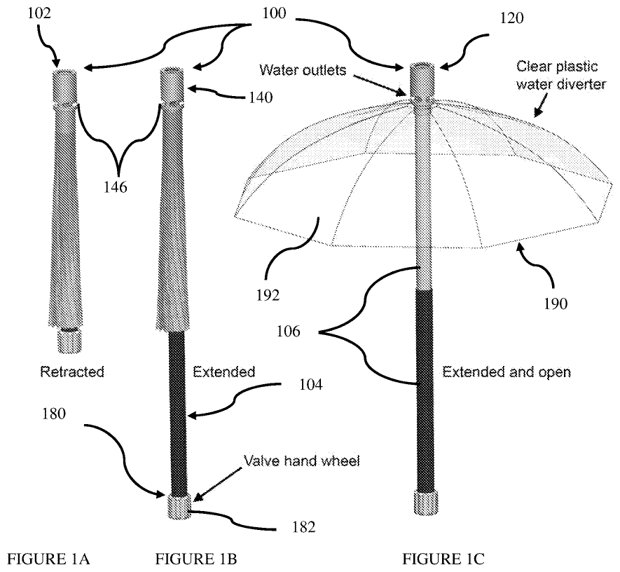

FIGS. 1A; 1B; and 1C show one embodiment of a tool 100 according to the invention. The body 102 comprises collar 120 and casing 140. The casing 140 houses one or more fluid outlet 146. Also shown is actuator 180. The one or more fluid outlet 146 are disposed above the fluid diverter 190. The diverter 190 is shown in the form of an umbrella comprising a canopy 192. This positioning means that a user remains completely dry during use, from start to end. By constructing diverter 190 from a transparent material, such as a clear plastic, good visibility is also provided so that the user can align and easily connect tool 100 to the sprinkler 400 in need of shutting off.

Because sprinklers 400 are installed at, or near, the ceiling, the embodiment of fire sprinkler shut off tool 100 shown in FIGS. 1A; 1B; and 1C is shown to comprise an elongate handle or rod 104 to aid reaching the height of the sprinklers 400. Advantageously, tool 100, shown in FIGS. 1A; 1B; and 1C comprises a telescoping mechanism comprised of telescoping segments 106 (not shown), so that a sprinkler 400 may be shut off without access to a ladder, chair or the like. For typical ceiling heights (below 3 metres), a multi-stage telescoping mechanism may be retracted to a length of around 30 cm for practical and compact storage. In other embodiments, handle or rod 104, when present, may comprise a fixed length.

A flexible member such as a spring or elastomer can attach the fire sprinkler shut off tool 100 to the handle or rod 104 to assist connection by permitting the flexibility to improve the alignment during connection. A gimble swivel can also be employed to assist alignment as this will ensure the tool 100 is always plumb, as will be the axis of an installed sprinkler 400.

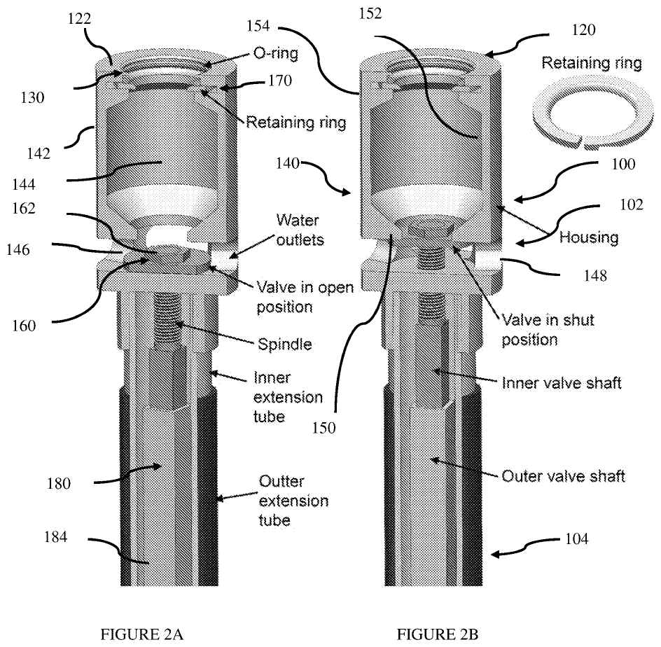

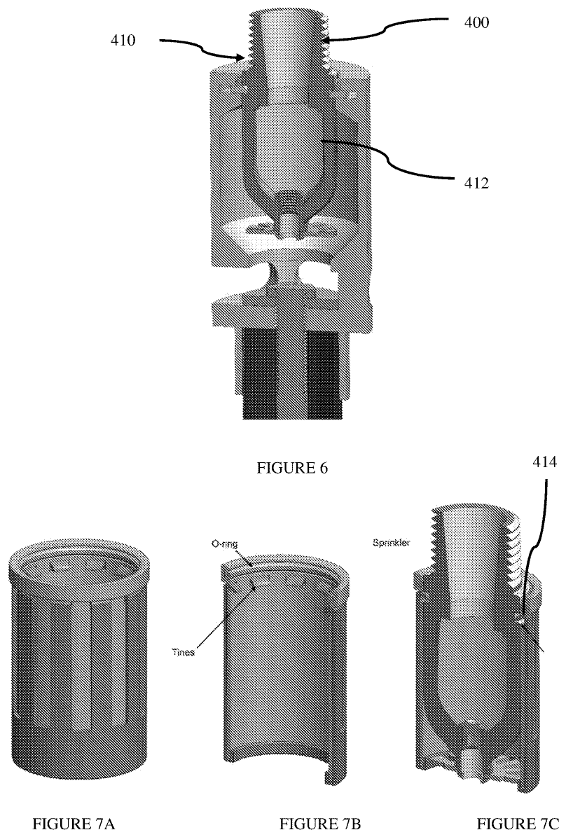

FIGS. 2A and 2B show sectional views of the proximal end of one embodiment of a shut off tool 100 according to one embodiment of the invention. The collar 120 has a slightly larger diameter than the sealing surface diameter of the sprinkler 400 and/or adaptor 500 (not shown) to which tool 100 is to be fitted. When inserted over sprinkler 400, the one or more fastener 170 for connecting to sprinkler 400, in this embodiment shown as a ‘circlip style’ retaining ring, is opened beyond it's natural relaxed state because the frame arms 412 disposed on sprinkler 400 taper outward (see FIG. 6). Once aligned, the retaining ring 170 locates in the sprinkler's groove 414 (best seen in FIG. 7C) and locks the tool 100 over the sprinkler 400. At this location, the hydraulic seal or part thereof 130 (see FIG. 2A), in this embodiment an O-ring, makes a pressure and fluid-tight seal around the cylindrical machined part of sprinkler 400 to block fluid.

Advantageously, connecting fire sprinkler shut off tool 100 to a sprinkler 400 is easy, even when fluid is being discharged at a typical high flow rate and under typical high pressure. This is because the one or more fluid outlet 146 at the bottom of casing 140 pass the fluid right through with minimal restriction or pressure build-up. It would be impossible to connect any vessel to an operating sprinkler if the vessel had a restrictive outlet orifice. To assist with the positioning of the fire sprinkler shut off tool 100, in the embodiment shown in FIGS. 2A and 2B, the one or more fluid outlet 146 comprise a size at least as large as the conduit 144 defined by wall 142 of casing 140. The size of the one or more fluid outlet 146 may be the combined size at the one or more exit ports 148 compared to the size of the conduit 144. The size may be the area in mm2 or cm2.

Once fire sprinkler shut off tool 100 is connected, if present, tool actuator 180, shown in the embodiment of FIGS. 1A; 1B; 1C; 2A; and 2B as a hand wheel 182 may be turned, which in turn rotates connecting shaft 184 and eventually raises the threaded spindle valve member 162, of valve 160, against the valve seat 150, disposed on casing 140, which completely blocks the conduit 144 upstream of one or more fluid outlet 146. With valve 160 closed, the fire sprinkler shut off tool 100 stops all fluid flowing from sprinkler 400. That is, valve 160 is movable between the open position shown in FIG. 2A, which allows fluid to exit from the one or more fluid outlet 146, and the closed position, shown in FIG. 2B, in which fluid is blocked from exiting the one or more fluid outlet 146. In FIG. 2B, valve member 162 forms a seal with valve seat 150. Although valve seat 150 is shown to be comprised on casing 140, in other embodiments the valve seat 150 may be comprised on body 102 or collar 120. In the embodiment shown in FIGS. 2A and 2B, the valve seat 150 is located above the one or more fluid outlet 146 to block fluid flow when valve 160 is closed.

Collar 120 is adapted to be directly coupled to the sprinkler 400 though in other embodiments, the fire sprinkler shut off tool 100 may be indirectly coupled such as, via an adaptor 500 connecting the sprinkler 400 to the fluid supply pipe.

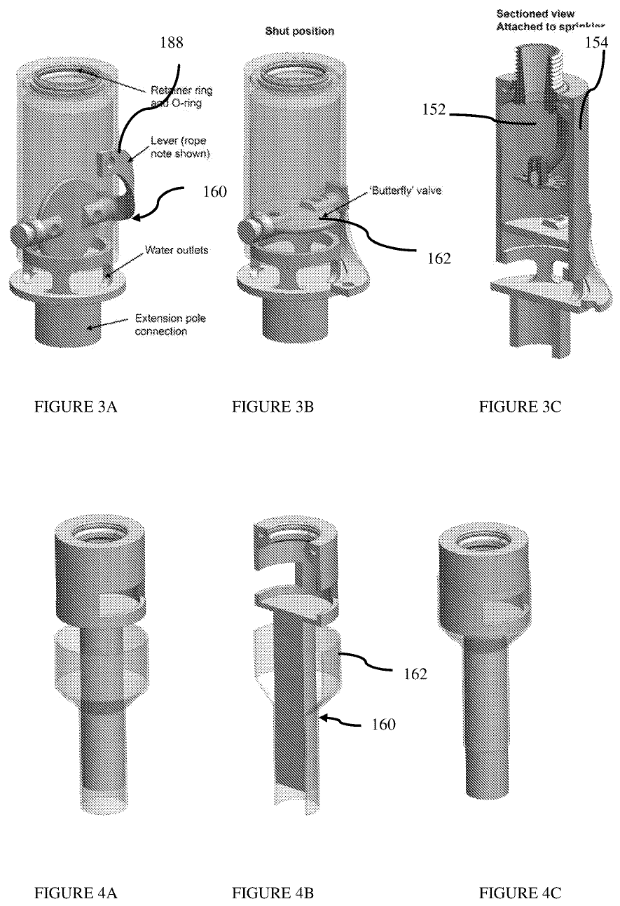

FIGS. 3A; 3B; and 3C show another embodiment of tool 300 in which valve 160 is a butterfly valve. Valve member 162 is opened and closed by actuator 180, in the form of a cord 186 (see FIG. 9). The butterfly valve requires a quarter of a turn rotation of valve member 162 to shut flow. The user may operate the butterfly valve 160 from below, by pulling a rope or cord 186 fastened to the hole in lever 188 or by operating lever 188 directly.

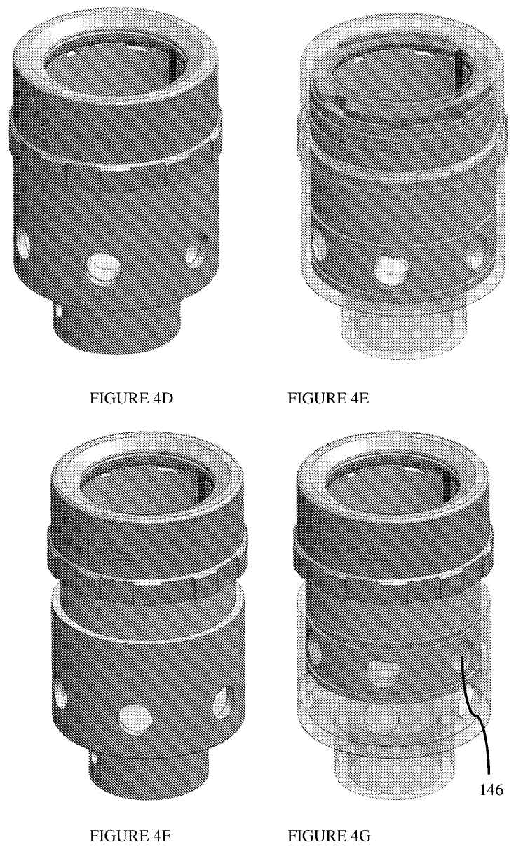

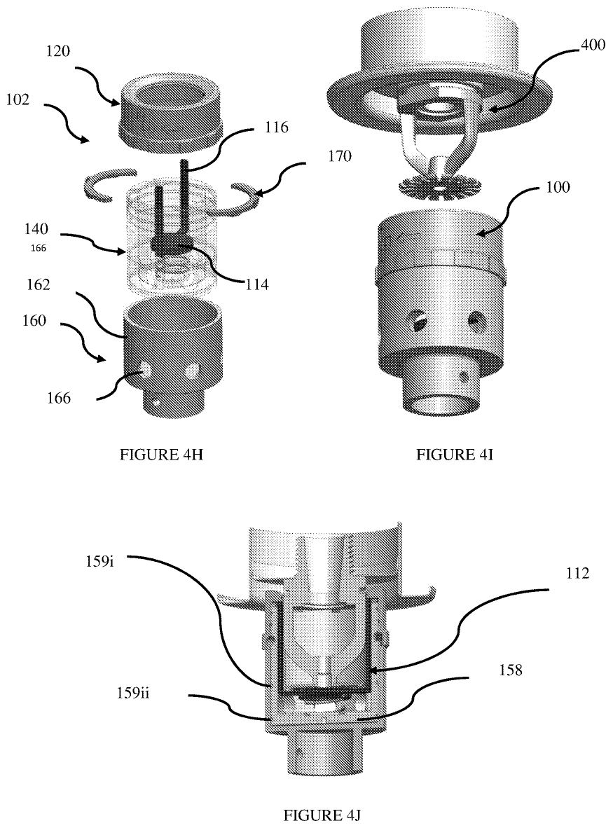

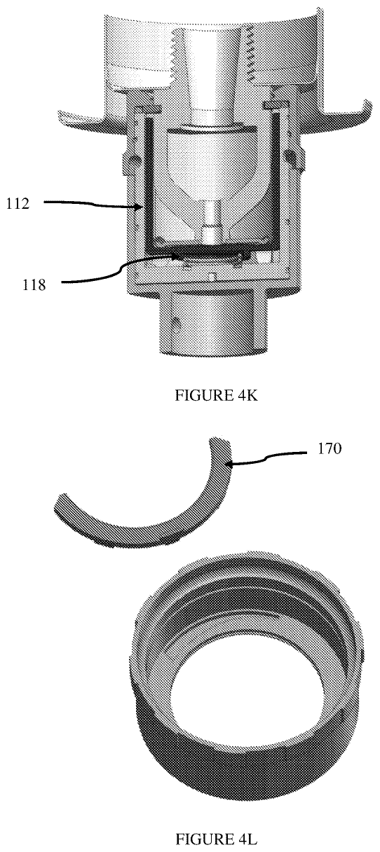

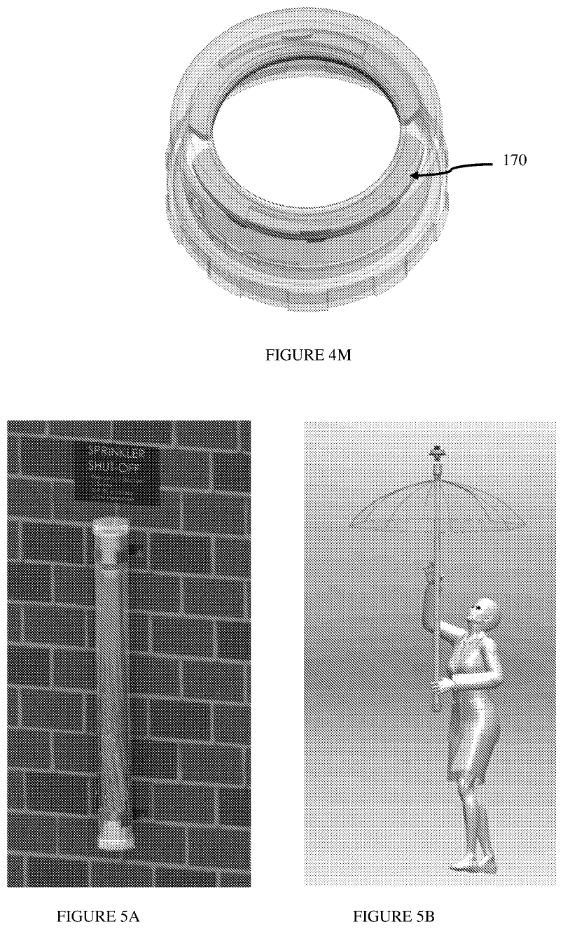

FIGS. 4A; 4B; and 4C show another embodiment in which valve 160 comprises a sleeve valve. In this embodiment flow is stopped when sleeve valve member 162 is lifted over the one or more fluid outlet 146 and latched in that position. In other embodiments, the sleeve valve member 162 may be pulled, lifted or rotated such that the sleeve valve member 162 closes the one or more fluid outlet 146.

While the embodiments of FIGS. 1; 2; 3 and 4A to 4C feature a collar 120 comprised within the casing 140, the embodiment of FIGS. 4D to 4M comprises a body 102 comprising two or more pieces namely, a collar piece 120 and a casing piece 140.

FIGS. 4D; 4E; 4F; 4G; 4H; 4I; 4J; 4K; 4L; and 4M; show another sleeve valve embodiment, one in which a trigger is fitted to ensure the retainers are held open to facilitate easy connection. To shut off flow, the user simply needs to continue pushing up firmly as this will raise the sleeve valve member over the one or more fluid outlet. The complete operation occurs in two separate stages, firstly pushing over will attach the sprinkler when the one or more fastener locates in the sprinkler's groove, then pulling the sleeve down blocks the fluid outlets of the housing.

FIGS. 4D (perspective view) and 4E (phantom view) both show the tool 100 in a valve open configuration.

FIGS. 4F (perspective view) and 4G (phantom view) both show the tool 100 in a valve shut configuration.

FIG. 4H shows a partially exploded view with retaining rings easily visible. FIG. 4I shows the tool 100 in position ready for deployment over sprinkler 400.

FIG. 4J shows that pushing body 102 over sprinkler 400 depresses trigger 112. The trigger 112 comprises a bias and is in the form of a spring.

The trigger prevents the retainer 170 from moving inward under the bias of a leaf spring 172 (not shown) until sprinkler 400 pushes trigger 112 beyond the point at which it is able to continue to hold back retainer 170, permitting the retainer 170 to be pushed by their leaf spring 172 (not shown), into the groove of the sprinkler 400 or adaptor 500, thereby fastening tool 100 to the sprinkler 400 or adaptor 500.

Advantageously, trigger 112 ensures that no components such as, retainer 170 can interfere with the connection of tool 100 to a sprinkler 400.

From the teaching herein the skilled person readily understands that any suitable mechanical fastener may be used for one or more fastener 170 including a bayonet style connection.

From the teaching herein the skilled person readily understands that any suitable valve 160 may be used such that the invention is not limited to a plug valve; a butterfly valve; a ball valve; diaphragm valve and/or a sleeve valve.

Also, from the teaching herein the skilled person understands that the valve member 162 may be any suitable valve member such as, a plug or stopper, a disc or a sleeve. The disc may comprise a rotatable disc and/or may be circular.

While collar 120, and its top surface 122, are shown to be annular, from the teaching herein the skilled person understands collar 120 may have any convenient shape for engaging with sprinkler 400 or adaptor. Collar 120 is also shown to comprise a larger diameter than a sealing surface diameter of the sprinkler 400 to which the fire sprinkler shut off device 100 is to be fitted.

In the embodiments of FIGS. 1 to 3 and 4A to 4C, collar 120 is integral with casing 140. In the embodiment of FIGS. 4D to 4M, casing 140 is movable relative to collar 120 between an open position in which fluid can escape from the one or more fluid outlet 146 and a closed position in which the one or more fluid outlet 146 is closed so that no fluid can escape. The movement is illustrated to be along an extent of a collar wall 142 and/or a casing wall 142. In other embodiments, this movement may be linear, rotational or linear and rotational. The movement may close valve 160.

Pushing tool 100 onto sprinkler 400 also raises the sleeve 160 relative to the casing 140 and this aligns the one or more outlet 146 with the one or more valve outlet 166 disposed in sleeve 160, which in this construction form valve members 162. The aligned holes 148, 166 permit water flowing from the sprinkler 400 to flow out of the tool 100 when trying to connect to the sprinkler 400. Without the alignment of the holes 148, 166, pressure would build in the tool 100 and it would be impossible to connect. Once connected the user lets go of the tool 100 and the sleeve 160 drops down with gravity under the weight of the attached handle/extension pole 104 (not shown in FIG. 4). When the sleeve 160 drops the holes in the housing 148 are sealed by the sleeve 160 and water is completely shut from the sprinkler 400 (scaled by o-rings 156 where required). This embodiment is particularly advantageous as the user simply pushes the tool 100 over the sprinkler 400 and does not need to shut a secondary valve or rotate to lock etc. This provides the untrained occupant with a means of stopping flooding without requiring assistance.

That is applying tool 100 moves the sleeve 160 relative to the casing 140 to an intermediate sleeve open position in which the one or more fluid outlets 148 are open. The intermediate sleeve open position is shown to be a raising or lifting of the sleeve 160. Once the tool 100 is installed on the fire sprinkler 400 or the adaptor 500, the sleeve 160 may move relative to the casing 140 to a sleeve closed position in which the one or more fluid outlets 148 are closed. The sleeve closed position, compared to the intermediate sleeve open position, is illustrated to be a dropping or a lowering of sleeve 160. The closed position may be biased by gravity and/or a weight of a handle or rod 104 or a water diverter such as an umbrella 190.

In another embodiment, sleeve 160 may be rotated relative to the casing 140 so that the sleeve open position aligns the one or more fluid outlet 148 with corresponding one or more valve outlet 166 disposed in sleeve 160, and for the sleeve closed position, the sleeve 160 may be rotated relative to casing 140 so that the one or more fluid outlet 148 and the corresponding one or more valve outlet 166 are not aligned.

The embodiment shown in FIGS. 4D to 4M also shows body 102 to comprise a trigger 112. Applying the body 102 over the sprinkler 400 or adaptor 500 may depress trigger 112. Trigger 112 comprises a bias 118, illustrated in the form of a spring. Trigger 112 comprises vertical struts 116 which in a biased position prevent retainer 170 from fastening to sprinkler 400 or adaptor 500. The vertical struts 116 extend from base 114 which is disposed to make contact with a sprinkler 400 or adaptor 500. The retainer 170 is biased to move inward by a spring such as, a leaf spring. Inserting sprinkler 400 or adaptor 500 moves trigger 112 against bias 118 to move vertical struts 116 away from contact with retainer 170 so retainer 170 fastens to the sprinkler or adaptor.

The second sleeve embodiment of FIGS. 4D to 4M comprises a collar piece 120 and a casing piece 140.

Casing 140 comprises one or more outlet seal or part thereof 156 to prevent water leaking. In the embodiment shown in FIGS. 4D to 4M, the one or more outlet seal or part thereof 156 are in the form of an O-ring. Although the or more outlet seal or part thereof 156 themselves, are not shown in FIGS. 4D to 4M, grooves 159 for housing the O-rings are shown.

From FIG. 4J it can be seen that one or more outlet seal or part thereof 158 comprises an open position outlet seal or part thereof 158i and a closed position outlet seal or part thereof 158ii. This is apparent because, although the one or more outlet seal or part thereof 158i,ii are not shown, the corresponding grooves 159i and 159ii are labelled. These grooves 159i,ii on casing 140 accommodate the O-rings.

The open position outlet seal or part thereof 158i is shown to be positioned above the closed position outlet seal or part thereof 158ii. The one or more outlet seal or part thereof 158 may comprise a planar surface or a surface which compresses to planar on sealing. The one or more outlet seal or part thereof 158 may engage with a correspondingly shaped element on the valve such as, a sleeve.

In the embodiment of FIGS. 4D to 4M the one or more fastener 170 is in the form of retaining arcs.

The casing of FIGS. 4D to 4M is also shown to comprise bottom wall 158 and the one or more outlets 148 are shown to be comprised in a casing side wall 142. The casing bottom wall 158 is shown to be continuous that is, it is not compromised by any holes or outlets.

Pushing the tool 100 all the way allows the retainers 170 to be pushed into the groove on the sprinkler 400, thereby locking the tool 100 to the sprinkler 400. The retainer 170 is spring loaded (not shown) with a leaf spring.

FIG. 4L is a view of the underside of the retainer 170. The protruding cam locates in the tapered slot on the underside of the collar 120 of the tool 100. When the collar 120 is rotated, the retainers will open, permitting the tool 100 to be released from the sprinkler when required.

FIG. 4M is a top view of the collar 120 shown in phantom and the protruding cam of retainer 170 can be seen nested into the tapered slot of collar 120. Rotating collar 120 clockwise as viewed from the top pushes the cam and therefore the retainer 170 radially outward.

One or more interfitting retaining elements 108 (not shown) may hold casing 140 in the closed position. The one or more interfitting retaining elements 108 may comprise corresponding retaining elements 108 disposed on the collar 120 and casing 140. The one or more interfitting retaining elements 108 may operate in both the open position and the closed position or only the closed position. The interfitting retaining elements may comprise one or more: corresponding thread; male component; female component; or other fasteners. The one or more male component may comprise one or more protrusion. The one or more female component may comprise one or more recess. The one or more female component may comprise one or more groove. The one or more male component may comprise one or more tabs. The tabs may lock in the grooves which may prevent return travel or release.

The interfitting retaining elements 108 may be disposed on an internal surface 152 of casing 140. Casing 140 also comprises an external surface 154.

The fire sprinkler shut off device 100 may also be provisioned to provide an intentional supervisory leak. The purpose of such an intentional supervisory leak is to ensure that after a shutoff tool is used, the occupant proceeds with having the operated sprinkler replaced. The intentional supervisory leak may result from a channel 110 (not shown) that may be through the valve 160 or valve member 162 or the hydraulic seal or part thereof 130. The channel 110 may only be oriented to allow fluid flow when the valve 160 or valve member 162 is closed. The deliberate leak may allow only sufficient water to cause a leak and not sufficient water to extinguish a fire.

The embodiments of FIGS. 2A; 2B; 3A; 3B; 3C; 4A; 4B; and 4C, show shut off tool hydraulic seal or part thereof 130 to be comprised within the collar 120. In other embodiments, shut off tool hydraulic seal or part thereof 130 is disposed proximal to collar 120. The shut off tool hydraulic seal or part thereof 130 may comprise a planar surface or a surface which compresses to planar on sealing. The shut off shut off tool hydraulic seal or part thereof 130 may engage with a correspondingly shaped element on the sprinkler 400 or adaptor. The correspondingly shaped element on the sprinkler 400 or adaptor may be retrofitted or retro-designed for the sprinkler 400 or adaptor.

The one or more fastener 170 may comprise a mechanical fastener dimensioned to fasten to a mechanical element on the one or more sprinkler 400 or adaptor. The mechanical element on the one or more sprinkler 400 or adaptor may be a complementary fastener or a native sprinkler or adaptor mechanical element.

FIGS. 7A; 7B; and 7C illustrate an embodiment in which the one or more fastener 170 comprises a plurality of tines. These flexible tines are configured to flex outward when the sprinkler 400 is inserted, until the point where the tine ends align with the groove 414 in the sprinkler 400 at which point they snap into the groove 414. Once located in the groove 414, the sprinkler 400 cannot be removed even once the fire sprinkler shut off tool 100 is fully pressurized.

The tines may be manufactured from stamped stainless steel approximately 1 mm thick, allowing sufficient ‘flex’ over the length.

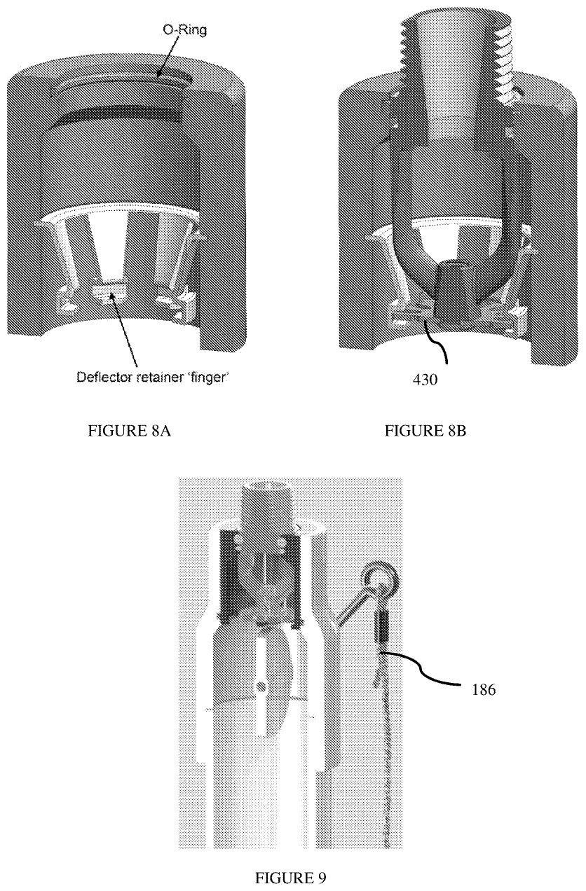

FIGS. 8A; 8B; 8C; shown an embodiment in which the one or more fastener 170 comprises a plurality of deflector fingers which may be disposed for fastening to a deflector 430 of the sprinkler. The flexible retainer fingers are configured to flex backward as sprinkler 400 is inserted, up to the point where the finger snaps over the deflector 430 and locks it in this position, even when the fire sprinkler shut off tool 100 is fully pressurized.

The embodiment of FIGS. 8A; 8B; and 8C highlights another important advantage of the present invention, namely that the fire sprinkler shut off tool 100 may be applied to any current or traditional or non-connectable sprinkler 400 and not only to connectible sprinklers 400 fabricated with a dedicated groove 414. As such this embodiment can be configured to be used with the many millions of sprinklers already installed globally.

The one or more fastener 170 may be comprised within the collar 120 or alternatively proximal to collar 120. In different embodiments, the one or more fastener 170 may be disposed either above or below the hydraulic seal or part thereof 130 on casing 140.

Advantageously, the fire sprinkler shut off tool 100 is suitable for use with both a connectable sprinkler 400 or connectable adaptor and traditional or non-connectable sprinklers and traditional or non-connectable adaptors. By connectable sprinkler 400 or adaptor is meant one comprising one or more sprinkler or adaptor fastener for attachment to a tool such as, a drain tool or shut off tool 100. The sprinkler or adaptor to which the fire sprinkler shut off tool 100 is attached, be it a connectable sprinkler 400 or adaptor or a traditional or non-connectable sprinkler or adaptor, may comprise a sprinkler hydraulic seal or part thereof 440 (not shown).

The adaptor may be a sprinkler adaptor; a sprinkler pipe adaptor; or a sprinkler system adaptor. The adaptor may be an intermediary allowing connection between a sprinkler or sprinkler head and a sprinkler pipe.

FIGS. 2A; 2B; 3A; 3B; 3C; 4A; 4B; and 4C show valve 160 being closed by operating actuator 180 either distally via the handle or rod 104 or proximally by turning lever 188.

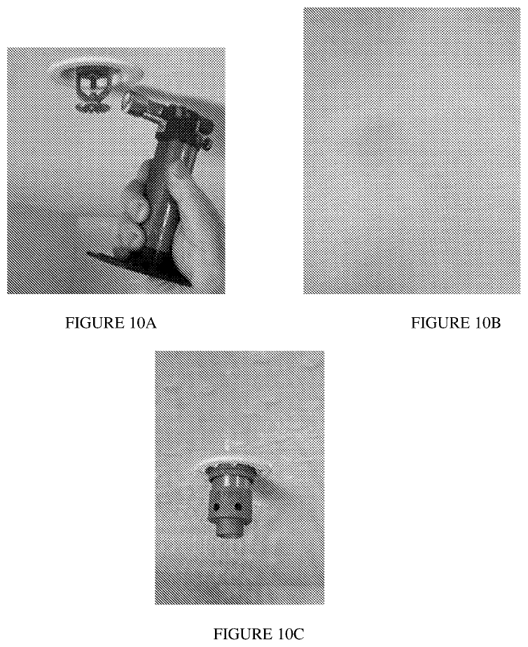

FIGS. 2A; 2B; 3A; 3B; 3C; 4A; 4B; and 4C show valve 160 being moved from the open position to the closed position by applying force, by hand, to an actuator 180. In other embodiments, such as the one shown in FIGS. 4D to 4M and FIG. 10C, no separate actuator 180 is required, and valve 160 is closed by moving casing 140 with respect to collar 120.

The person of skill in the art readily understands that the force used to close valve 160 may comprise one or more of: pushing; pulling; rotating; rotating and pushing; rotting and pulling; twisting; twisting and pushing; twisting and pulling; sliding; sliding and twisting; and sliding and rotating.

Although not shown, from the teaching herein the skilled person understands that a secondary flow actuator, which may move the valve member 160 to the open position to allow flow through the flow passage, may be comprised. The secondary flow actuator may comprise a heat sensing element. When, present the secondary flow actuator allows a sprinkler 400 that has been shut off by fire sprinkler shut off tool 100 to be reactivated and again allow fluid to flow. The outlet orifice may be fashioned to distribute the discharge in a uniform pattern, similar to a sprinkler's typical discharge.

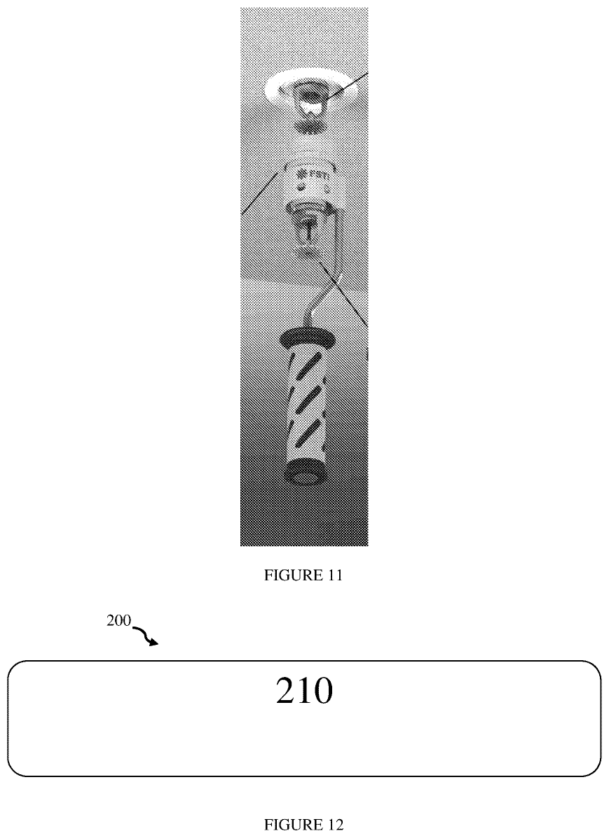

Another safety feature is shown in FIG. 11, which shows a failsafe sprinkler 400 comprised on the fire sprinkler shut off device 100. The failsafe sprinkler 400 comprises a responsive element such as, temperature responsive bulb. Advantageously, the fitting receiving the failsafe sprinkler can accept any sprinkler so that the fire sprinkler shut off tool 100 may be readily fitted with sprinklers of compatible types for the building they are fitted in. This is advantageous as shutoff tools 100 may be provided for the building using the exact type of failsafe sprinkler used for that hazard, location and installation orientation to ensure the suppression performance is appropriate.

The fire sprinkler 400 or adaptor utilised with fire sprinkler shut off tool 100 may comprise a connectable fire sprinkler or adaptor configured to engage with a drain tool or the fire sprinkler shut off tool such as, that described in WO 2015/003226, the publication of PCT/AU2014/050119, to Shae METE and assigned to FIRE SPRINKLER TECHNOLOGIES PTY LTD.

The fire sprinkler 400 or adaptor utilised with fire sprinkler shut off tool 100 may comprise a fire sprinkler or adaptor fastener for complementary fastening with the one or more fastener 170. The fire sprinkler or adaptor fastener may comprise a traditional or non-connectable sprinkler or sprinkler head component such as, deflector 430.

The fire sprinkler 400 may comprise a pendant fire sprinkler or a non-protruding fire sprinkler (concealed or flush mounted sprinkler) comprising a cover plate which may be ejected when the flow actuator activates.

From the teaching herein, the skilled person readily understands that the fire sprinkler to which fire sprinkler shut off tool is to be attached comprises one or more of: an attachment for installation on a pipe network; a deflector; and a flow actuator. The flow actuator may comprise a temperature responsive element such as, a bulb or soldered link. A deflector plate may be suspended from a deflector housing by one or more suspender. Each of the one or more suspender may comprise a suspender rod or suspender cable.

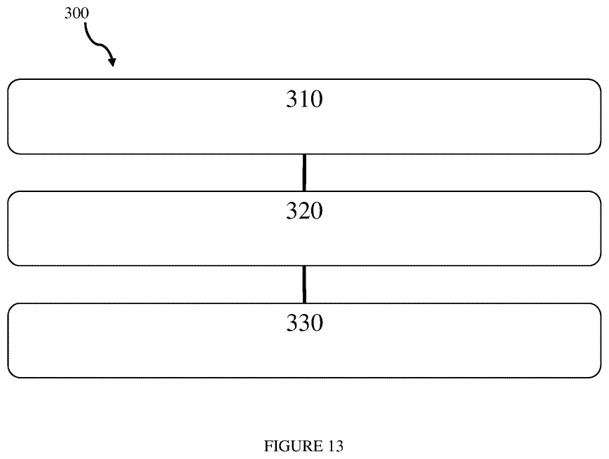

As shown in FIG. 12, the invention also provides a method 200 of shutting off a fire sprinkler 400, the method comprising installing 210 the fire sprinkler shut off tool 100 over a fire sprinkler 400 in need of being shut off.

FIG. 13 shows a method 300 of manufacturing a fire sprinkler shut off tool 100 comprising: providing 310 a body comprising a collar 120, a casing 140 and a shut off tool hydraulic seal or part thereof 130 to block fluid, the collar 120 for surrounding a sprinkler 400 or an adaptor, the casing 140 comprising a wall 142 and defining a conduit 144 the casing 140 also comprising one or more fluid outlet 146; providing 320 a valve 160 movable between an open position to allow fluid to exit from the one or more fluid outlet 146 and a closed position in which fluid is blocked from exiting the one or more fluid outlet 146; and providing 330 one or more fastener 170 to connect to the sprinkler 400 or adaptor.

The fire sprinkler shut off tool 100 advantageously provides a safety device intended to be used by an untrained building occupant or apartment owner, to prevent the need to wait for emergency responders to shut of the sprinkler systems. This significantly minimises fluid damage in the event that a connectable sprinkler has accidentally operated.

In buildings where sprinklers are installed, one or more fire sprinkler shut off tools 100 may be placed in each room or common areas alongside existing fire protection equipment such as extinguishers, hose reels and fire indicator panels. As depicted in FIG. 5A, shut off tool 100 may be fitted in a clear protective tube and may include identification signage with emergency instructions. Apartment owners or tenants can also purchase fire sprinkler shut off tools 100 for use in their own units.

If a sprinkler has operated by accidental impact or non-fire related heat, the user may remove fire sprinkler shut off tool 100 from the protective cover, then extend the telescoping handle or rod 104. The umbrella 192 may automatically open so that the user can remain dry when approaching the spraying sprinkler. As shown in FIG. 5B, the user then simply pushes tool 100 over the sprinkler to attach it and then closes the hand wheel at the bottom to stop the flow of fluid from the sprinkler or in the case of the embodiment in FIG. 10, flow will be shut automatically after pushing over the sprinkler.

Although it has been described with reference to various activation and actuator mechanisms, the fire sprinkler shut off tool 100 of the invention is not so limited. In various embodiments, the fire sprinkler shut off tool 100 may be actuated with one or more of: rotating; rotating and pushing; rotating and pulling; twisting; twisting and pushing; twisting and pulling; sliding; sliding and twisting; and sliding and rotating motion. From the teaching herein, a skilled person is readily able to select a suitable actuating mechanism and thereby a suitable actuation motion.

Advantageously, the fire sprinkler shut off tool 100 of the invention targets the problem of an activated fire sprinkler 400 that is no longer required to discharge fluid. Furthermore, the fire sprinkler shut off tool 100 of the invention is simple to use, such that no training or complex instruction is required.

The present claimed invention provides occupants of buildings in which the fire sprinkler shut off tool 100 is available, the ability to quickly and easily shut off an accidently, other otherwise activated sprinkler. This is a highly desirable feature for both current residential and commercial buildings and for the future of automatic fluid (water)-based suppression. More and more, legislation is requiring sprinkler protection in residential occupancies world-wide and incidents of water damage are increasing.

The present invention is described below with reference to both pendant fire sprinklers and non-protruding fire sprinklers. However, the invention is not so limited and may be applied to any type of fire sprinkler. From the teaching herein, a skilled person is readily able to adapt the invention described herein to other types of fire sprinkler.

The following non-limiting example illustrates the invention. This example should not be construed as limiting: the example is included for the purposes of illustration only. The Example will be understood to represent an exemplification of the invention.

### EXAMPLES

FIGS. 10A; 10B; and 10C show screenshots of a video showing subjecting a fire sprinkler 400 to heat (10A); the fire sprinkler 400 activated and dispensing water (10B); and the fire sprinkler 400 shut off with one embodiment of a device 100 according to the invention. The flow of water out of the activated sprinkler 400, shown in FIG. 10B, is such that fire sprinkler shut off device 100, while present in frame, to be positioned of onto the activated sprinkler, can not be seen.

The advantages of the present invention include that it can be operated by untrained building occupants immediately after accidental operation and has the ability to decrease fluid damage from accidental operation of sprinklers. Such damage is mostly caused by impact or heat generated by occupants. This means occupants are generally present and capable of quickly using the technology of the invention to stop water damage. This is of significant benefit given this damage costs millions of dollars per year.

Another advantage is that fire fighters attending real fires that have activated the sprinkler system currently have no choice but to shut off the entire sprinkler system upon arrival to stop water damage. The system won't be re-instated until sprinkler service technicians attend. Should a fire rekindle, no sprinklers will be able to extinguish the fire. Such events have occurred and proven to have caused significant loss.

A further advantage is that the present invention provides a solution for residents and businesses nervous about fire sprinkler protection due to their awareness or experience with water damage events. It is well understood that a significant proportion of homeowners would choose to not have a sprinkler system even if installation was free.

Another advantage of the technology of the invention is that it may result in an increased take-up of sprinkler protection in general which will be welcomed by building regulators and sprinkler manufacturers alike.

In this specification, the terms “comprises”, “comprising” or similar terms are intended to mean a non-exclusive inclusion, such that an apparatus that comprises a list of elements does not include those elements solely, but may well include other elements not listed.

Throughout the specification the aim has been to describe the invention without limiting the invention to any one embodiment or specific collection of features. Persons skilled in the relevant art may realize variations from the specific embodiments that will nonetheless fall within the scope of the invention.

1. A fire sprinkler shut off tool comprising:
a body comprising a collar, a casing and a shut off tool hydraulic seal or part thereof to block fluid, the collar for surrounding a sprinkler or an adaptor, the casing comprising a wall and defining a conduit, the casing also comprising one or more fluid outlet;
a valve movable between an open position to allow fluid to exit from the one or more fluid outlet and a closed position in which fluid is blocked from exiting the one or more fluid outlet; and
one or more fastener to connect to the sprinkler or adaptor.

2. A method of shutting off a fire sprinkler, the method comprising installing the fire sprinkler shut off tool of claim 1 over a fire sprinkler in need of being shut off.

3. A method of shutting off a fire sprinkler, the method comprising:
installing a fire sprinkler shut off tool over a sprinkler in need of shutting off or an adaptor, the fire sprinkler shut off tool comprising:
a body comprising a collar, a casing and a shut off tool hydraulic seal or part thereof to block fluid, the collar for surrounding a sprinkler or an adaptor, the casing comprising a wall and defining a conduit, the casing also comprising one or more fluid outlet;
a valve movable between an open position to allow fluid to exit from the one or more fluid outlet and a closed position in which fluid is blocked from exiting the one or more fluid outlet; and
one or more fastener to connect to the sprinkler or adaptor.

4. A method of manufacturing a fire sprinkler shut off tool comprising:
providing a body comprising a collar, a casing and a shut off tool hydraulic seal or part thereof to block fluid, the collar for surrounding a sprinkler or an adaptor, the casing comprising a wall and defining a conduit, the casing also comprising one or more fluid outlet;
providing a valve movable between an open position to allow fluid to exit from the one or more fluid outlet and a closed position in which fluid is blocked from exiting the one or more fluid outlet; and
providing one or more fastener to connect to the sprinkler or adaptor.

5. The tool according to claim 1 wherein the collar is integral with the casing.

6. The tool according to claim 1 wherein the casing is movable relative to the collar from an open position in which fluid can escape from the one or more fluid outlet to a closed position in which the one or more fluid outlet is closed so that no fluid can escape.

7. The tool according to claim 6 wherein the movement closes the valve.

8. The tool according to claim 1 wherein the one or more fluid outlet comprises a size at least as large as the conduit.

9. The tool according to claim 8 wherein the size of the one or more fluid outlet is the combined size at the one or more exit port.

10. The tool according to claim 9 wherein the shut off tool hydraulic seal or part thereof comprises an O-ring.

11. The tool according to claim 1 wherein the shut off tool hydraulic seal or part thereof engages with a correspondingly shaped element on the sprinkler or adaptor.

12. The tool according to claim 11 wherein the correspondingly shaped element on the sprinkler or adaptor is retrofitted or retro-designed for the sprinkler or adaptor.

13. The tool according to claim 1 wherein one or more interfitting retaining elements hold the casing in the closed position.

14. The tool according to claim 1 wherein the one or more fastener comprises a mechanical fastener dimensioned to fasten to a mechanical element on the one or more sprinkler or adaptor.

15. The tool according claim 14 wherein the mechanical element on the one or more sprinkler or adaptor may be a complementary fastener or a native sprinkler or adaptor mechanical element.

16. The tool or method according to claim 1 wherein the body comprises a valve seat.

17. The tool according to claim 1 wherein an actuator is comprised and applying force to the actuator moves the valve from the open position to the closed position.

18. The tool according to claim 1 wherein the sprinkler or adaptor is a connectable sprinkler or connectable adaptor comprising one or more sprinkler or adaptor fastener for attachment to a tool such as, a drain tool or the shut off tool.

19. The tool according to claim 1 wherein the sprinkler or adaptor may comprise a traditional or non-connectable sprinkler or adaptor.

20. The tool according to claim 1 wherein the adaptor comprises a sprinkler adaptor; a sprinkler pipe adaptor; or a sprinkler system adaptor.

21. The tool according to claim 1 wherein the fire sprinkler shut off device comprises an intentional supervisory leak.

22. The tool according to claim 1 wherein the tool comprises a diverter or an umbrella.
